(19) United States
(12) Patent Application Publication
(10) Pub. No.: US 2019/0004723 A1
(43) Pub. Date: Jan. 3, 2019

(54) THROTTLING COMPONENTS OF A STORAGE DEVICE

(71) Applicant: HEWLETT-PACKARD DEVELOPMENT COMPANY, L.P., Houston, TX (US)

(72) Inventors: Yu-Hung LI, Taipei City (TW); Yu-Chen CHENG, Taipei City (TW)

(21) Appl. No.: 15/748,646

(22) PCT Filed: Nov. 4, 2015
(86) PCT No.: PCT/US2015/059002

§ 371 Date: Jan. 29, 2018

(51) Int. Cl. G06F 3/06; G01K 1/14

(52) U.S. Cl. CPC G06F 3/0634; G01K 1/14; G06F 3/0679; G06F 3/0604

(57) ABSTRACT

Techniques relating to throttling components of a storage device are described herein. In an example, inputs corresponding to operating temperatures of a set of components of the storage device are received from a plurality of temperature sensors. Each of the plurality of temperature sensors is associated with a component from amongst the set components of the storage device. Based on the inputs, a throttling condition, from amongst a plurality of predefined throttling conditions, each defined for predetermined operating temperatures of the set of components, is determined. At least one components of the storage device is then throttled based on the throttling condition.

### BACKGROUND

Electronic devices, such as smart phones, laptops, notebook computers, digital cameras, gaming consoles and other computing devices incorporate storage devices to store data. With the recent growth in the volume of data generated by users, demand for storage devices has increased drastically. Storage devices that consume low power, have high operating speed, and are small in size have a significant demand in the electronics market.

As the storage devices become more and more compact in size are made to achieve higher operating speed, various heat dissipation measures are adopted to control the operating temperature of the storage devices to enable proper functioning of the storage devices.

### BRIEF DESCRIPTION OF FIGURES

The following detailed description references the drawings, wherein:

FIG. 1 illustrates a storage device, in accordance with one example implementation of the present subject matter;

FIG. 2 illustrates a solid state device according to an example of the present subject matter;

FIG. 3 illustrates the solid state device according to another example of the present subject matter;

FIG. 4 illustrates a method for throttling components of a storage device, in accordance with one example implementation of the present subject matter; and

FIG. 5 illustrates a method for throttling components of a solid state device, in accordance with one example implementation of the present subject matter.

### DETAILED DESCRIPTION

The rate at which heat generated by a computer component is dissipated during its operation, is one factor affecting the performance of the component. Accordingly, techniques, such as throttling are generally implemented to achieve high performance of the component. In general, throttling entails regulating power consumption of the component in order to control the amount of heat generated by the component.

The amount of power consumed by the component, for example, a controller for a storage device, is usually a function of frequency and voltage of the power supplied to the component. Accordingly, when the voltage is increased, the, frequency may be increased, resulting in a nonlinear increase in power consumption. The amount of heat generated by the component is based on the amount of power the component consumes. Reducing the power consumed by the component, by controlling the voltage or frequency or both supplied to the component, may enable reduction in amount of heat generated by the component. Thus, regulating the power consumed by the component by way of throttling is a mechanism to maintain the operating temperature of the component within a desired limit. As will be understood, throttling a component may cause the component to deliver reduced throughput in proportion to the reduction in power.

Generally, the temperature of one or more components in a storage device is monitored. When the temperature of any of the components reaches, a predefined threshold temperature, all the components are throttled. In such techniques, the components that are not yet heated to the extent that they be throttled are also throttled resulting in reduced performance of the storage device.

In an alternate technique, various components of the storage device may be monitored, and the components are individually throttled depending, on their respective temperature. Such techniques, where each component is throttled in isolation, are generally inaccurate and inefficient since such techniques do not take into consideration operational interdependencies that the components may have on each other.

For example, consider a storage device having a memory controller, a buffer memory component and several non-volatile memory components. The memory controller may receive data from a host, place it intermittently in the buffer memory component and then write the data to any of the non-volatile memory components. The rate of data transfer achieved at the non-volatile memory components is dependent on that of the buffer memory component and in turn on that of the memory controller. In such a scenario, if to the buffer memory component is throttled based on its operating temperature, the performance of the non-volatile memory components too reduces. Similarly, if the performance of the memory controller is throttled based on its operating temperature, the buffer memory component and in turn the non-volatile memory components perform data transfer operations at a slower rate. Thus, in storage devices, it may be inaccurate to throttle a component based on the temperature of that component independent of consideration of the temperature of any other component.

In accordance with one example implementation of the present subject matter, methods and systems for throttling components of a storage device are described. In an example implementation, operating temperatures corresponding to a set of components of a storage device is received from various temperature sensors. The temperature sensors are associated with each component in the set of components such that operating temperatures of the set of components may be obtained. Based on the respective operating temperatures of the set of components, a throttling condition is determined and at least one of the components of the storage device is throttled based on the determined throttling condition.

In an example, the throttling condition is identified from amongst a plurality of predefined throttling conditions, wherein each of the predefined throttling conditions is defined based on predefined operating temperatures of the set of components. In an example, the predefined operating temperatures in a throttling condition may be based on the operational interdependencies of the set of such components. Each of the predefined throttling conditions define an overall throughput for the storage device. Throttling the storage device in accordance with a throttling condition that is based on operating temperatures of the set of components to ensure enhanced performance of the storage device.

The above discussed methods and systems for throttling components of a storage, device are further described in conjunction with the figures and associated description below. It should be noted that the description and figures merely illustrate the principles of the present subject matter. It will thus be appreciated that various arrangements that embody the principles of the present subject matter, although not explicitly described or shown herein, can be devised from the description and are included within its scope.

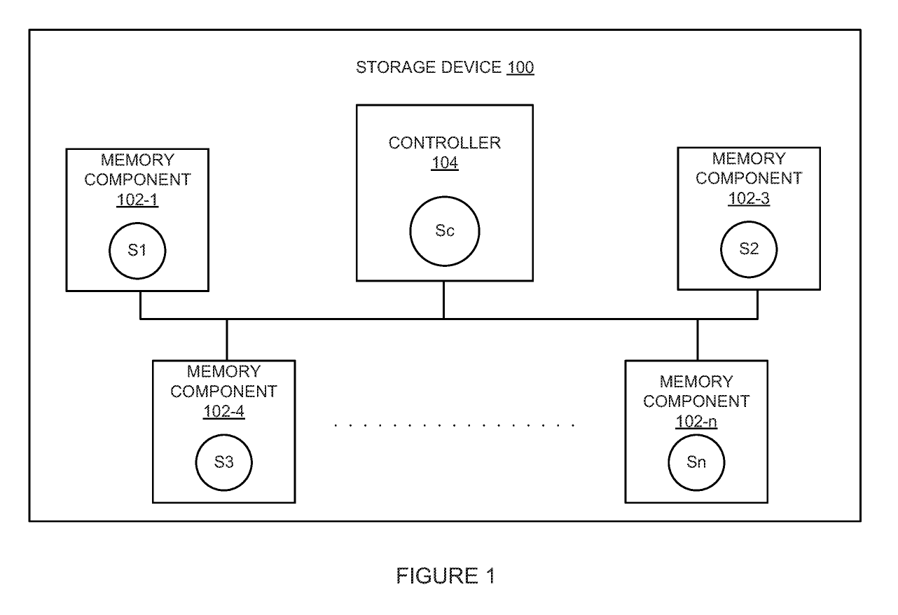

FIG. 1 illustrates a storage device 100, in accordance with one example implementation of the present subject matter. The storage device 100 may be, for example, a semiconductor based storage device used in computing devices, such as server computers, desktop computers, laptop computers, smartphones, tablets as well as in other electronic devices, such as media players, digital cameras and gaming consoles. Examples of the storage device 100 include, but are not restricted to, memory drives, such as solid state drives (SSD), solid state hybrid drives (SSHD) and flash drives; and memory cards, such as multi-media cards (MMC), secure digital (SD) cards and secure digital high capacity (SDHC) cards.

The storage device 100 includes one or more memory components 102-1, 102-2, 102-3, . . . , 102-n. The memory components 102-1, 102-2, 102-3 . . . 102-n of the storage device 100 store data received from a host and allow retrieval of such stored data. The host may be understood as a device to which the storage device 100 may be coupled to, or onto which the storage device 100 may be installed, for storage and retrieval of data. For example, the host may be any of the devices mentioned above. In an example, the memory components 102-1, 102-2, 102-3 . . . 102-n may be a non-volatile memory component, such as an array of rewritable NAND flash memory cells. Other examples of the memory component may include a random access memory (RAM) based memory component.

The storage device 100 includes a controller 104 to enable the data storage and retrieval operations. The controller 104 controls data exchange between the host and the memory components 102-1, 102-2, 102-3, . . . 102-n based on requests of the host. For example, the host may request for any of a read, write and erase operation of the data to be performed on the storage device 100. The controller 104 controls the data exchange between the host and the memory components 102-1, 102-2, 102-3 . . . 102-n, based on the request from the host.

In an implementation, the storage device 100 incorporates a plurality of temperature sensors S1, S2, S3, . . . Sn. The plurality of temperature sensors S1, S2, S3, . . . Sn may be associated with a set of memory components, from amongst the memory components 102-1, 102-2, 102-3 . . . 102-n, such that each memory components in the set is associated with at least one of the temperature sensors S1, S2, S3 . . . Sn.

The temperature sensors S1, S2 S3 . . . Sn detect an operating temperature of the memory components 102-1, 102-2, 102-3 . . . 102-n. The controller 104 is coupled to the plurality of the temperature sensors S1, S2, S3 . . . Sn to obtain the operating temperature of the memory components 102-1, 102-2, 102-3 . . . 102-n. Based on the operating temperatures of the memory components 102-1, 102-2, 102-3 . . . 102-n, received from the temperature sensors S1, S2, S3 . . . Sn, the controller 104 determines a throttling condition. The throttling condition is indicative of an overall throughput for the storage device 100 that may be obtained while the throttling condition is implemented. The overall throughput may be an optimum throughput based on the operating temperatures of the memory components 102-1, 102-2, 102-3 . . . 102-n. The controller 104, upon determining the throttling condition, throttles performance of the storage device 100 based on the throttling condition. In an example, the throttling condition may be maintained till the operating temperatures of the memory components 102-1, 102-2, 102-3 . . . 102-n drop below a predefined value.

For example, based on the operating temperature of the memory components 102-1, 102-2, 102-3 . . . 102-n, the throttling condition may indicate that the throughput of the storage device 100 to be reduced to 75% of its rated throughput. Accordingly, the controller 104 throttles the performance of any of the components of the storage device 100 to achieve the indicated overall throughput. The throttling condition is based on the operating temperature of a set of memory components 102-1, 102-2, 142-3 . . . 102-n and not temperature of an individual component thereby resulting in more accurate throttling. Further details relating to the throttling process have been elaborated subsequently.

In addition to the memory components 102-1, 102-2, 102-3 . . . 102-n, the storage device 100 may include other component (not shown in the figure) that enable other internal operations of the storage device 100. For instance, one of the other components may be a host interface that allows the storage device 100 to communicate with a host. Examples of such other components also include timers, clock generators, and various communication buses.

Depending on the implementation, a temperature sensor may also be associated with one or more of the other components so that such components are monitored for performance throttling. For instance, in some example implementations, a temperature sensor may be coupled to one or more programmable memory component, such as a read-only memory (ROM) based memory components, implemented in the storage, device 100, for example, to, store ark operating system of the storage device 100. Some examples of the storage device 100 may include a buffer memory component where the data from the host is intermittently stored before writing to one of the memory components 102-1, 102-2, 102-3 . . . 102-n. In some implementations, operating temperature of the buffer memory component may be obtained through an associated temperature sensor. Accordingly, the throttling condition may take corresponding operating temperatures of such other components into consideration in some implementations.

In some examples, the temperature of the, controller 104 may also be taken into consideration to determine the throttling condition. For the purpose, a temperature sensor Sc may be associated with the controller 104. It will be understood that the overall performance of storage devices that comprise a controller to control the data storage and retrieval process, is dependent on the performance of the controller. Accordingly, the temperature of the controller may be one of the factors for defining the throttling conditions. One example of such a storage device is a solid state device (SSD).

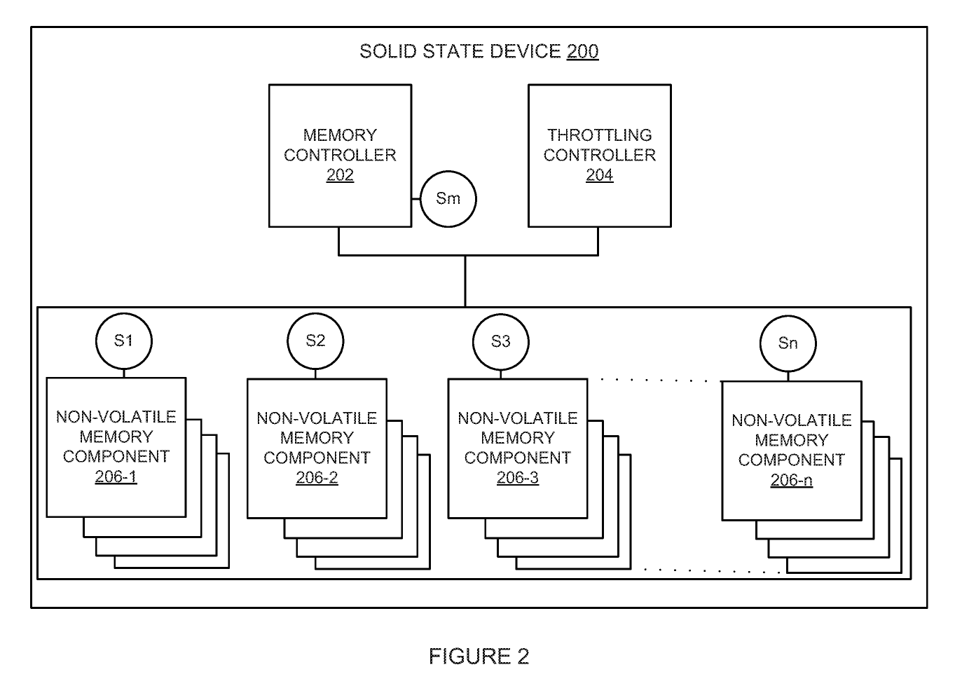

FIG. 2 illustrates an example SSD 200 on which throttling of different components may be implemented in consistence with the described implementations. In an example implementation, the SSD 200 may be any solid state drives, hybrid solid state drives, and other Dynamic Random Access Memory (DRAM) based drives.

In an example implementation as illustrated in the FIG. 2, the SSD 200 may include various components, such as a memory controller 202, a throttling controller 204, and a plurality of non-volatile memory components 206-1, 206-2, 206-3 . . . 206-n. The various components r ay work in co-ordination with each other to perform different operations related to storage of data on the SSD 200.

In accordance with an example implementation of the present subject matter, the plurality of non-volatile memory components 206-1, 206-2, 206-3 . . . 206-n may include memory cells, which may be, for example, NAND flash based memory cells. Other examples of the non-volatile memory components 206-1, 206-2, 206-3 . . . 206-n may include Single Level Cell (SLC) flash memory and Multi Level Cell (MLC) flash memory. The plurality of non-volatile memory components 206-1, 206-2, 206-3. . . 206-n may provide a storage volume of the SSD 200. In an example implementation of the present subject matter, the memory cells may be arranged in an array based architecture. For the purpose of ease of explanation, the plurality of non-volatile memory components 206-1, 206-2, 206-3 . . . 206-n may be together referred as non-volatile memory components 206, hereinafter.

According to an example implementation of the present subject matter, the memory cells of the non-volatile memory components 206 may be grouped. A group may include a number of memory cells, such as a page, block, plane, die, or any other combination of memory cells. For example, some groups may include a number of pages of memory cells that make up a block of memory cells. A number of blocks may be included in a plane of memory cells. A number of planes of memory cells may be included on a die. Thus, a plurality of such groups of non-volatile memory components 206 may be present in the SSD 200.

The memory controller 202 may perform one or more of read operations, write operations, erase operations, and any other operations on the plurality of non-volatile components 206. According to an, example implementation, the memory controller 202 may have firmware and/or circuitry that may be, for example, a number of integrated circuits and/or discrete components for controlling access across the plurality of non-volatile memory components 206 and provide communication amongst the various components on the SSD 200.

According to an example implementation of the present subject matter, the memory controller 202 may be coupled to a temperature sensor Sm. Further, at least one of the plurality of groups of the non-volatile memory components 206 may be coupled to temperature sensors S1, S2, S3, . . . Sn, respectively. Each of the temperature sensors Sm, S1, S2, S3 . . . Sn may be capable of sensing and monitoring the temperature of the memory controller 202 and various non-volatile memory components 206, respectively, with which the temperature sensors are associated. It may be understood that in different example implementations of the present subject matter, groups of the non-volatile memory components 206, such as a page, block, plane, die, or other groups of the non-volatile memory components 206, may be formed. The temperature sensors S1, S2, S3, . . . Sn may be associated with at least one group of the non-volatile memory components 206, from amongst the various groups of non-volatile memory components 206 of the SSD 200.

In an example implementation of the present subject matter, the SSD 200 may implement the throttling controller 204 to throttle the various components of the SSD 200. The throttling controller 204 may be any dedicated processor, such as a microcontroller or a microprocessor, implemented to perform the functions relating to throttling of components of the SSD 200 in accordance with the subject matter described herein. It may be noted that example implementations, including the throttling controller 204, are in contrast to the previously discussed implementations, where a controller responsible for managing the data storage and retrieval operations, i.e., controller 104, was to perform the throttling also. Accordingly, based on design considerations, in some example implementations, the memory controller 202 may incorporate the throttling controller 204 to perform various operations relating to thermal management of the various components on the SSD 208.

In an example implementation, the throttling controller 204 may be coupled to the memory controller 202 and the non-volatile memory components 206. In operation, the throttling controller 204 may obtain respective temperatures, of the memory controller 202 and each of the at least one group of the non-volatile memory components 206 through the respective temperature sensors Sm, S1, S2, S4, S5, . . . Sn. The operating temperatures for each of the least one group of non-volatile memory components 206 may be represented as Ta, Tb, Tc . . . Tn and the operating temperature of the memory controller 202 may be represented as Tm, respectively.

In one example implementation of the present subject matter, the throttling controller 204 may initiate a request for receiving the operating temperatures of each of the non-volatile components 206. In another example implementation, the throttling controller 204 may periodically receive the operating temperatures of the non-volatile memory components 206 and the memory controller 202 based on a pre-defined rule preconfigured within the throttling controller 204. For example, the throttling controller 204 may implement a pre-defined rule to receive the operating temperatures after execution of every nth operation from the various components of the SSD 200. Alternatively, in other example implementations of the present subject matter, the throttling controller 204 may set any other pre-defined rule for receiving the operating temperatures. In one of the example implementation, the throttling controller 204 may obtain the operating temperatures from the non-volatile components 206 and the memory controller 202 simultaneously, such that the obtained operating temperatures may be considered together for further processing as explained below.

Upon obtaining the operating temperatures of the group of non volatile components 206 and the memory controller 202, the throttling controller 204 may identify a throttling condition indicating an overall throughput of the SSD. For example, the throttling controller 204 may identify a throttling condition to set a throughput of the SSD 200 to any of 100%, 75%, 50%, and 25% of its rated value throughput based on the obtained operating temperatures.

In an example, a throttling condition may be as follows:

IF (Ta<Ta′∥Tb<Tb′∥Tc<Tc′ . . . Tn<Tn′μTm<Tm′) THEN THROUGHPUT=75%,

In the above equation, Ta′, Tb′, Tc′ . . . Tn′ and Tm are predefined threshold temperatures specified for the at least one group of non-volatile memory components 206 and the memory controller 202, respectively. In one example, the throttling condition identified may be:

IF (Ta<Ta′+Na∥Tb<Tb′+Nb∥Tc<Tc′+Nc . . . Tn<Tn′Nt∥Tm<Tm′+Nm) THEN THROUGHPUT=50%,

In the above equation, Ta′+Na, Tb′+Nb, Tc′+Nc . . . Tn′+Nn and Tm′+Nm may be a different set of threshold temperatures predefined for the at least one group of non-volatile memory components 206 and the memory controller 202, respectively.

For example, the throttling controller 204 may identify the throttling condition that defines the overall throughput of the SSD 200 to be set to 75% of a maximum throughput achievable by the SSD 200 when each of the operating temperatures Ta, Tb, Tc . . . Tn and Tm of the at least one group of non-volatile memory components 206 and the memory controller 202, respectively, obtained at the throttling controller 204, is less than threshold temperatures Ta′, Tb′, Tc′ . . . Tn′ and Tm′ corresponding to the non-volatile memory components 206 and the memory controller 202, respectively.

As explained previously, the throttling controller 204 identifies the throttling condition from amongst a plurality of predefined throttling conditions corresponding to different operating temperatures of the at least one group of non-volatile memory components 206 and the memory controller 202. Each throttling condition is defined based on predefined operating temperatures corresponding to the at least one group of non-volatile memory components 206 as well as the memory controller 202. In one example implementation, to identify the throttling condition the throttling controller 204 may compare the respective operating temperatures of the at least one group of non-volatile memory components 206 and the memory controller 202 with corresponding, temperatures of the at least one group of non-volatile memory components 206 and the memory controller 202 defined in the plurality of predefined throttling conditions. Accordingly, in implementations of the present subject matter, each of the predefined throttling conditions is based on operating temperatures of a plurality of components of a storage device taken into consideration simultaneously, to render greater accuracy to the throttling process.

Upon identifying the throttling condition, the throttling controller 204 may throttle performance of the solid state device based on the identified throttling condition. For the purpose, the throttling controller 204 may modify a frequency and/or a voltage supplied to the various components of the SSD 200. In one of the example implementations of the present subject matter, the throttling controller 204 may throttle the various components of the SSD 200 depending upon inter-operability dependence of the various components amongst each other. For example, the throttling controller 204 may reduce the operating work frequency of the memory controller 202 due to which the operating work frequency of the non-volatile memory components 206 may automatically get affected.

In an example, the throttling controller 204 may control the operating speed of one or more of the at least one group of non-volatile memory components 206 and the memory controller 202. Referring to the previous example, if the identified throttling condition defined the overall throughput of the SSD 200 to be set to 75%, the throttling controller 204 may throttle the at least one group of non-volatile memory components 206, the memory controller 202, or both to operate such that the overall throughput of the SSD is 75%.

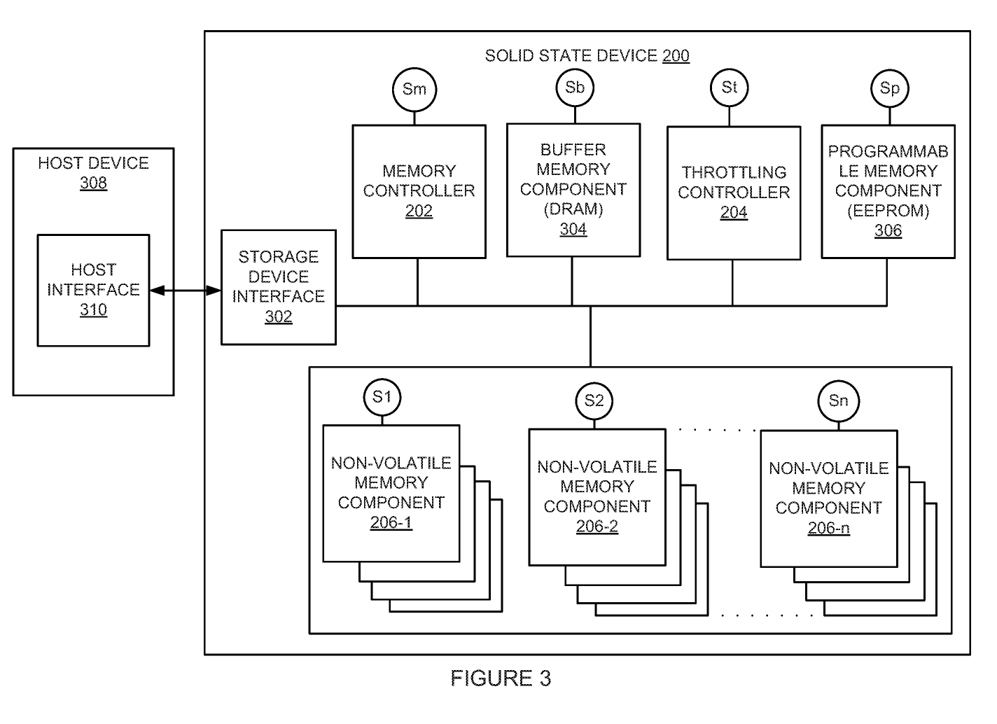

FIG. 3 illustrates the SSD 200 in accordance with another implementation of the present subject matter. According to the example implementation illustrated <in FIG. 3, the SSD 200 may be coupled to a host device 308 through a storage device interface 302 of the SSD 200. The host device 308 may include a host interface 310 to communicate with the SSD 200. The host interface 310, in co-ordination with the storage device interface 302 of the SSD 200 may perform data exchange between the host device 308 and the SSD 200. The host interface 310 may be coupled to the, storage device interface 302 of the SSD 200 via any of a Serial Advanced Technology Attachment (SATA) interface, a Universal serial bus (USB) interface, an Multi Media Card (MMC) interface, a Parallel Advanced Technology Attachment (PATH) interface, an Institute of Electrical and Electronics Engineer (IEEE) 1394 interface, a Peripheral Component Interconnect Express (PCI-E) interface an Secure Digital (SD) interface, a Compact Flash (CF) interface, an Integrated Drive Electronics (IDE) interface, and other standardized interfaces.

In an example implementation of the present subject matter, the SSD 200 comprises a buffer memory component 304. The buffer memory component 304 is coupled to the memory controller 202 and the non-volatile memory components 206. In the present example implementation, the memory controller 202 may temporarily store the data on the buffer memory component 304, before actually storing the data on any of the non-volatile memory components 206. The buffer memory component 304 may temporarily store the commands and data received from the host device 308 via the memory controller 202 for data exchange between the host device 308 and the SSD 200. Also, the buffer memory component 304 may temporarily store the data retrieved from any of the non-volatile memory components 206 to be communicated to the host device 308. In one example, the buffer memory component 304 may be a volatile memory component, such as a dynamic random access memory (DRAM).

In an example implementation of he present subject matter, the SSD 200 includes a programmable memory component 306 to store, among other data, the predefined throttling conditions based on which the throttling may be performed. For example, the programmable memory component 306 may be an Erasable Programmable Read Only Memory (EEPROM) device and the predefined throttling conditions may be written onto the EEPROM device by way of applying a programming voltage.

In accordance with example implementations of the present subject matter, temperature sensors may be associated with a set of components of a storage device, such as the SSD 200 that are to be monitored for performance throttling, in accordance with examples of the present subject matter, in case the storage device heats up during operation. Various sets of components of a storage device, not restricting to the ones described in the subsequent examples, may be monitored for performance throttling.

In an example implementation, the memory controller 202, the, buffer memory component 304, and four groups of the non-volatile memory components 206 may be the set of components that may be monitored to throttle the performance of the SDD 200. Temperature sensors, Sm, Sb, S1, S2, S3 and S4 are coupled to the memory controller 202, the buffer memory component 304, and the four groups of the non-volatile memory components 206, respectively, to measure their operating, temperatures. Further, the predefined throttling conditions may be defined for a plurality of set of predefined operating temperatures of the memory controller 202, the buffer memory component 304, and the four groups of the non-volatile memory components 206. Table 1 illustrates three example predefined throttling conditions defined for the example set of monitored components.

TABLE 1

| | | | |
|---|---|---|---|
| Respective | Sm < 90 | Sm < 95 | Sm < 100 |
| temperatures of the | Sb < 75 | Sb < 80 | Sb < 95 |
| monitored | S1 < 70 | S1 < 75 | S1 < 85 |
| components | S2 < 70 | S2 < 75 | S2 < 85 |
| | S3 < 70 | S3 < 75 | S3 < 85 |
| | S4 < 70 | S4 < 75 | S4 < 85 |
| Overall throughput | 3000 MB/s | 2250 MB/s | 300 MB/s |

Depending upon the opera temperatures of the memory controller 202, the buffer memory component 304, and the four groups of the non-volatile memory components 206, respectively, obtained by the throttling controller 204 from associated temperature sensors Sm, Sb, S1, S2, S3 and S4, the throttling controller 204 may identify any one of the predefined throttling conditions. In an example, the throttling controller 204 may match the obtained respective operating temperatures with corresponding operating temperatures specified in each of the plurality of predefined throttling conditions, that may he stored, in programmable memory component 306, to identify the throttling condition.

Based on the identified throttling condition, an overall throughput for the SSD 200 is determined. In an example, the overall throughput for the SSD 200 is provided in MB/s. The throttling controller 204, thereupon throttles one or more components of the SSD 200 to achieve the overall throughout in one example, the throttling controller 204 may throttle a component from amongst the monitored components. However, examples where other components of the SSD 200, i.e., components other than the monitored components, may be throttled are also possible.

As explained before, the memory controller 202, the throttling controller 204, the buffer memory component 304, and any of the non-volatile memory components 206 depend on each other, such that, operations executed by the any one of the components effects the operations to be performed on remaining components. For example, in one scenario, operating speed of the non-volatile memory components 206 may depend upon the rate of data received from the buffer memory component 304 which further depends upon the rate at which the data is temporarily stored on the buffer memory component 304 by the memory controller 202.

According to an example implementation of the present subject matter, throttling the various components of the SSD 200 may include controlling the operating speed of the memory controller 202 to control the operating speed of one or more of the buffer memory component 304 and the non-volatile memory components 206, to achieve the overall throughput based on the identified throttling condition. According to another example implementation of the present subject matter, throttling may include controlling the operating speed of the buffer memory component 304 to control the speed of the non-volatile memory components 206. Thus, the throttling controller 204 may selectively control the operating speed of any of the various components on the SSD 200 in any combination to perform the throttling.

Although the various implementations above have been provided based on an example set of monitored components comprising the memory controller 202, the buffer memory component 304, and the four groups of the non-volatile memory components 206, various other implementation are feasible. For example, the programmable memory component 306 may be one of the components that may be monitored. A temperature sensor Sp may be coupled to the programmable memory component 306 to provide the operating temperature of the programmable memory component 308 to the throttling controller 204. The throttling controller 204 may use the operating temperature of the programmable memory component 308 to identify the throttling condition. As will be understood, in present example, the predefined throttling conditions may be defined accordingly by incorporating predefined operating temperatures amongst that of other monitored components. In one implementation, the throttling controller 204 may also be one of the monitored components. The throttling controller 204 may read its operating temperature using a temperature sensor St that may be coupled to the throttling controller 204.

In an example, the number of components to be monitored may be based on design and cost considerations. For instance, a size constraint of a storage device may limit the number of temperature sensors to ‘n’. In another example, a requirement for higher accuracy of the throttling process may allow the number of temperature sensors and in turn the number of monitored components to be ‘n+x’.

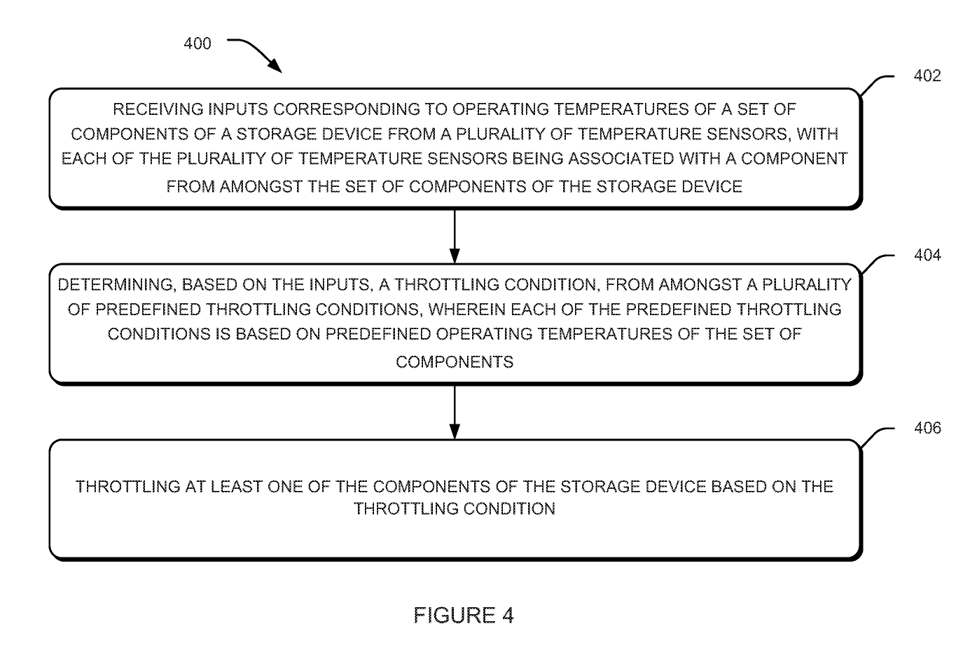

FIG. 4 illustrates a method 400 for throttling components of a storage device, in accordance with one example implementation of the present subject matter.

The order in which the method 400 is described is not intended to be construed as a limitation, and any number of the described method blocks can be combined in any order to implement the method 400, or an alternative method. Additionally, individual blocks may be deleted from the method 400 without departing from the spirit and scope of the subject matter described herein. Furthermore, the method 400 can be implemented in any suitable hardware, software, firmware, or combination thereof.

Further, although the method 400 for throttling components of a storage, device may be implemented in a variety of storage device associated with different user devices, in examples described in FIG. 4, the method 400 is explained in context of the aforementioned application storage device 200 for ease of understanding.

At block 402, inputs corresponding to operating temperatures of the set of components of a storage device are received from plurality of temperature sensors. As explained previously, temperature sensors may be associated with a component, from amongst the set of components, of the storage device that are to be monitored for throttling performance of the storage device on its getting heated in operation.

At block 404, based on the received inputs, a throttling condition, from amongst a plurality of predefined throttling conditions, is identified. As explained previously, each predefined throttling conditions is defined for a predefined operating temperatures of the set of components.

In one example, to identify the throttling condition, from amongst the plurality of predefined throttling conditions, the inputs corresponding to operating temperatures of the set of components of the storage device are to be taken into consideration together. Each of the predefined throttling conditions is based on a different set of pre-specified operating temperatures of the monitored components and defines an overall throughput. In an example, a set of operating temperatures may be pre-specified based on the operational interdependencies of the set of components for which the predefined throttling conditions are defined. Also, in an example, the overall throughput defined by the throttling condition may be an optimum throughput to be achieved corresponding to the operating temperatures of the set of components.

At block 406, at least one of the components of the storage device is throttled to accordance with the determined throttling condition. For instance, one or more of the components of the storage device that are monitored for performance throttling may be throttled based on the throttling condition, in an example, the throttling condition may be maintained till the operating temperatures of the set of components drop below a predefined value. Accordingly, the example method 400 provides for an optimum throughput to be achieved when throttling a storage device.

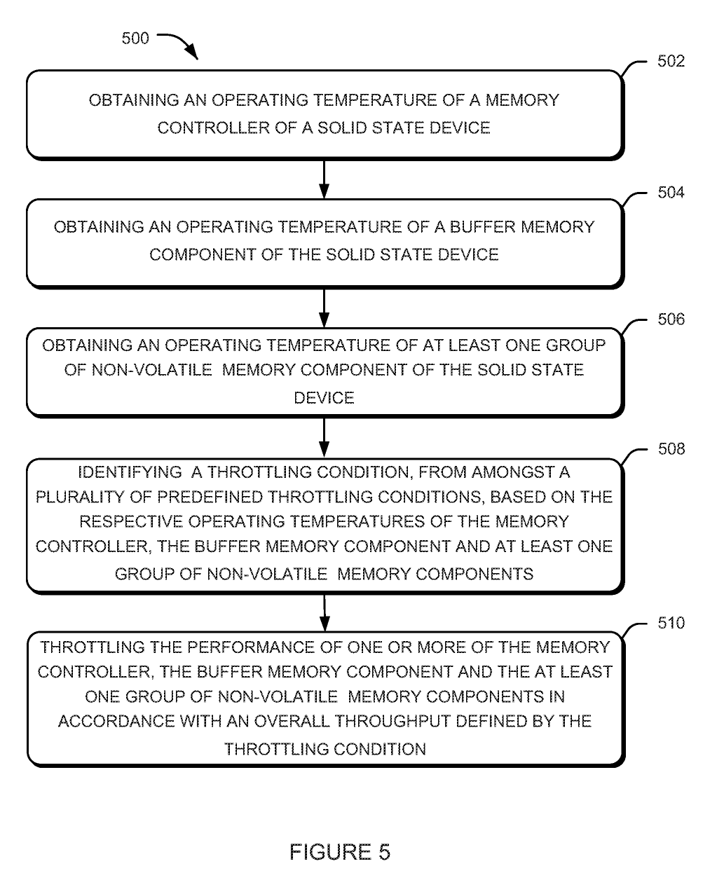

FIG. 5 illustrates a method 500 for throttling components of a solid state device, in accordance with one example implementation of the present subject matter. Alike method 400, the order in which the method 500 is described is also not intended to be construed as a limitation. Also, although the method 500 can be implemented in a variety of solid state devices, in examples described in FIG. 5, the method 500 is explained in context of the aforementioned example solid state device 200 and solid state device 300 for ease of understanding.

In an example implementation inputs relating to operating temperatures corresponding to components of a solid state device, such as the solid state device 200 that are monitored for performance throttling may be obtained. Accordingly, at block 502, an operating temperature of the memory controller 202 of the solid state device 200 is obtained. Similarly, at blocks 504 and 506, an operating temperature of the buffer memory component 304 and the temperature of the at least one of the groups of the non-volatile memory component 206, respectively, is obtained.

In example implementations where the memory controller 202, the buffer memory component 304 and the group of the non-volatile memory component 206 may be monitored to perform the throttling operations, the predefined throttling conditions may be defined accordingly. Thus, each of the predefined throttling conditions is based on corresponding operating temperatures of the memory controller 202, the buffer memory component 304 and the group of the non-volatile memory component 206. A plurality of predefined throttling conditions exist, such that each predefined throttling condition relates to a different set of predefined operating temperatures of the memory, controller 202, the buffer memory component 304 and the group of the non-volatile memory component 206. Further, each of the predefined throttling conditions is indicative of an overall throughput for the solid state device 200. For example, the overall throughput defined a throttling condition may be an optimum throughput that may be achieved when the obtained temperatures of the memory controller 202, the buffer memory component 304 and the group of the non-volatile memory component 206 match with the respective operating temperatures specified in the throttling condition.

At block 508, a throttling condition that corresponds to the obtained operating temperatures, is identified. At block 510, performance of one or more of the memory controller 202, the buffer memory component 304 and the group of the non-volatile memory component 206 is throttled in accordance with the overall throughput defined by the identified throttling condition.

The example implementations explained in FIG. 5 describe the throttling of components of the solid state device 200 based on operating temperatures of the memory controller 202, the buffer memory component 304 and at least one of the memory component 206. It will be understood that the memory controller 202, the buffer memory component 304 and at least one of the groups of non-volatile the memory component 206 are one example set of monitored components referred to for ease of understanding and various other implementations, where other components of the solid state device 200, for example, the programmable memory component 306, may be monitored and taken into consideration to perform the throttling, are also possible.

Although implementations of techniques relating to throttling components of a storage device have been described in language specific to structural features and/or methods, it would be understood that the appended claims are not necessarily limited to the specific features or methods described. Rather, the specific features and methods are disclosed as example implementations for throttling components of a storage device.

We claim:

1. A method comprising:
receiving inputs corresponding to operating temperatures of a set of components of a storage device from a plurality of temperature sensors, with each of the plurality of temperature sensors being associated with a component from amongst the set of components of the storage device:
determining, based on the inputs, a throttling condition from amongst a plurality of predefined throttling conditions, wherein each of the predefined throttling conditions is based on predefined operating temperatures of the set of components; and
throttling at least one of the components of the storage device based on the throttling condition.

2. The method of claim 1, wherein each of the plurality of predefined throttling conditions defines an overall throughput for the storage device.

3. The method of claim 1, wherein the storage device is a solid state device and wherein the set of components include a memory controller, a buffer memory component and at least one of a plurality of non-volatile memory components of the solid state device.

4. The method of wherein throttling comprises controlling operating speed of the memo controller to control speed of operation of the buffer memory component and the plurality of non-volatile memory components.

5. The method of claim 3, wherein throttling comprises controlling operating speed of the buffer memory component to control operation of the plurality of non-volatile memory components.

6. The method of claim 3, wherein throttling comprises controlling operating speed of at least one of the plurality of non-volatile memory components.

7. A storage device comprising:
memory components to store data;
a plurality of temperature sensors wherein each of the plurality of temperature sensors is associated with one of the memory components to detect an operating temperature of the memory components; and
a controller, coupled to the plurality of sensors, to:
obtain the operating temperature of the memory components;
determine, based on the operating temperature of the memory components, a throttling condition indicative of an overall throughput for the storage device; and
throttle, performance of at least one component of the rage device based on the throttling condition.

8. The storage device of claim 7, wherein the controller is associated with a temperature sensor, and is further to throttle the performance based on its operating temperature.

9. The storage device of claim 7, wherein the controller is to:
compare the operating temperature of each of the memory components against a plurality of predefined throttling conditions; and
determine the throttling condition based on the comparing.

10. The storage device of claim 7, wherein the at least, one component comprises one or more of the memory components the controller, a buffer memory component of the storage device and a programmable memory, component of the storage device.

11. A solid state device comprising:
at least one group of non-volatile memory components coupled to a temperature sensor;
a memory controller to perform read/write operations on the at least one group of non-volatile memory components, the memory controller being associated with a temperature sensor; and
a throttling controller to:
obtain an operating temperature of the at least one group of non-volatile memory components and an operating temperature of the memory controller from the respective, temperature sensors, based on the operating temperature of the at least one group of non-volatile memory components and the operating temperature of the memory controller, identify a throttling condition indicative of an overall throughput for the solid state device, and
throttle performance of the solid state device based on the throttling, condition.

12. The solid state device of claim 11, wherein to throttle performance of the solid state device, the throttling controller is to control operating speed of one or more of the at least one group of non-volatile memory components and the memory controller.

13. The solid state device of claim 11 further comprising a programmable memory, component accessible by the throttling controller, wherein the programmable memory component is to store a plurality of predefined throttling conditions, each of the plurality of predefined throttling conditions defined for a different operating temperature of the at least one group of the non-volatile memory components and of the memory controller.

14. The solid state device of claim 13, wherein the programmable memory component is coupled to a temperature sensor, wherein the throttling controller is to ascertain an operating temperature of programmable memory component from the temperature sensor to identify the throttling condition.

15. The solid state device of claim 11 further comprising a buffer memory component to transfer data between the memory controller and the at least one group of non-volatile memory components, the buffer memory component being coupled to a temperature sensor, wherein the throttling controller is to ascertain an operating temperature of the buffer memory component from the temperature sensor to identify the throttling condition.
